(19) United States
(12) Patent Application Publication
(10) Pub. No.: US 2008/0309068 A1
(43) Pub. Date: Dec. 18, 2008

(54) Pipe Insert

(75) Inventor: Derek Shane Hall, Western Australia (AU)

Correspondence Address: GOTTLIEB RACKMAN & REISMAN PC, 270 MADISON AVENUE, 8TH FLOOR, NEW YORK, NY, 10016-0601, US

(73) Assignee: HALL, DEREK SHANE, WARWICK (AU)

(21) Appl. No.: 10/592,012

(22) PCT Filed: Mar. 9, 2005
(86) PCT No.: PCT/AU05/00331

§ 371 Date: Dec. 8, 2006

(51) Int. Cl. F16L 25/00; B23P 11/00

(52) U.S. Cl. 285/31; 29/506

(57) ABSTRACT

A pipe insert (10) which in use is to provide a connection between spaced pipe ends (11), the insert having at least two ends, the pipe insert being adjustable to be able to vary the relative displacement between the ends, each end having connecting means (12) adapted to provide a sealing interconnection between that end and the respective pipe end. A method of connecting at least two pipe ends is also claimed.

### FIELD OF THE INVENTION

The present invention relates to a pipe insert and also to a method of connecting at least two pipe ends using such a pipe insert.

### BACKGROUND

Process piping installations are common to many industries, including the oil and gas, petrochemical and mining industries.

A requirement associated with most major projects concerning such installations is that the piping be hydrostatically and/or pneumatically tested, prior to pre-commissioning, so as to ensure conformity with design and operating parameters. Such testing is generally followed by a cleaning phase which may involve subsonic air blasting. Until the installation is commissioned, it is not desirable to expose control elements, such as valves and like elements, to the rigours that will be experienced during assembly of the installation, cleaning of the assembled installation and testing of the installation prior to commissioning.

For this reason, it is not uncommon for such control elements to be installed and then removed as many as three times over the course of construction, testing and cleaning. This generally involves construction of purpose-built temporary pipe inserts to replace each control element. In installations which incorporate tens or hundreds of control elements, this practice is unwieldy and wasteful because, in most instances, a new pipe insert is created each time for each control element and, where the installation is to be subjected to testing, each temporary insert must be fabricated to the same standards as the control element which it is intended to replace. Associated shortcomings in this regard include triple-handling and installation, which compromises the mechanical integrity of the pipe system, as well as the need to subject the temporary inserts to non-destructive testing to ensure their fitness for use during testing and cleaning. This results in unnecessary expense, time delays and safety risks. In addition, there is an increased likelihood of damage to the control elements each time they are installed and then removed

### DISCLOSURE OF THE INVENTION

Throughout this specification, unless the context requires otherwise, the word “comprise” or variations such as “comprises” or “comprising”, will be understood to imply the inclusion of a stated integer or group of integers but not the exclusion of any other integer or group of integers.

According to one aspect of the present invention, there is provided a pipe insert which in use is to provide a connection between spaced pipe ends, the insert having at least two ends, the pipe insert being adjustable to be able to vary the relative displacement between the ends, each end having connecting means adapted to provide a sealing interconnection between that end and the respective pipe end.

According to a preferred feature of the invention the pipe insert is able to accommodate flow between the pipe ends. According to a preferred feature of the invention the pipe insert constitutes a flow conduit between the ends. According to preferred feature of the invention the flow conduit comprises an integral part of the pipe insert. According to preferred feature of the invention the flow conduit is of a flexible or extendable nature. According to a preferred feature of the invention the pipe insert is adapted to receive at least one of a selection of flow control and/or sensing elements. According to a preferred feature of the invention the pipe insert incorporates a flow control and/or sensing elements.

According to an alternative preferred feature of the invention the pipe insert is not able to accommodate flow between the pipe ends.

According to a preferred feature of the invention, the pipe insert comprises a plurality of interengaged sections which are displaceable relative to each other to vary the relative displacement between the ends of the insert wherein the sections are sealingly interconnected. According to a preferred feature of the invention, the sections are telescopingly interconnected. According to an alternative preferred feature of the invention, the sections are threadably interengaged, whereby the relative displacement is varied by varying the relative longitudinal position of the threadable interconnection between the sections.

According to a preferred feature of the invention, the connecting means are selectable from a plurality of connecting means adapted to connect to pipe ends of differing sizes.

According to a preferred feature of the invention, the ends of the insert are displaceable along a longitudinal axis.

According to a preferred feature of the invention, the ends of the insert are displaceable along at least two longitudinal axes which are angularly displaced from each other. According to one embodiment, the ends of the insert are displaceable along two longitudinal axes which are substantially perpendicular to each other.

According to another aspect of the present invention, there is provided a method of connecting at least two spaced pipe ends, the method comprising the steps of:

providing an insert as described above;

adjusting the insert to cause relative displacement between the ends of the insert according to the spacing of the pipe ends; and

connecting the insert to the pipe ends with the connecting means.

The invention will be more fully understood in the light of the following description of specific embodiments.

### BRIEF DESCRIPTION OF THE DRAWINGS

The description is made with reference to the accompanying drawings of which:

FIG. 1 is a side elevation of a pipe insert, according to a first embodiment of the invention;

FIG. 2 is a sectional side elevation of the pipe insert according to a first embodiment of the invention as shown in FIG. 1, fitted with a lifting eye and ball valve;

FIG. 3 is a sectional side elevation view of a pipe insert according to a second embodiment of the invention, fitted with a pressure gauge and fill/drain point; and

FIG. 4 is a sectional side elevation of a pipe insert according to a third embodiment of the invention, fitted with a pressure gauge and lifting eye;

FIG. 5 is a sectional elevation of an insert according to a fourth embodiment in a retracted condition;

FIG. 6 is a sectional elevation of an insert according to a fourth embodiment in an extended condition;

FIGS. 7 and 8 are schematic sectional elevations of inserts according to further embodiments of the invention.

### DETAILED DESCRIPTION OF SPECIFIC EMBODIMENTS

Each of the embodiments is directed to a pipe insert which in use is to provide a connection between at least two spaced pipe ends and is adjustable along at least one axis to accommodate for the spacing between the pipe ends. The purpose of the pipe inserts of each of the embodiments is to replace a flow control and/or sensing element which is to be located between the pipe ends while the installation with which the pipe ends are associated is under construction, cleaning, testing, maintenance or a like activity and when it is inappropriate for the flow control and/or sensing element to be subjected to the conditions associated with that activity. It is intended that the pipe insert can be used repeatedly between the pipe ends or between a different set of pipe ends at each instance that it becomes necessary to remove the flow control and/or sensing element from between the pipe ends.

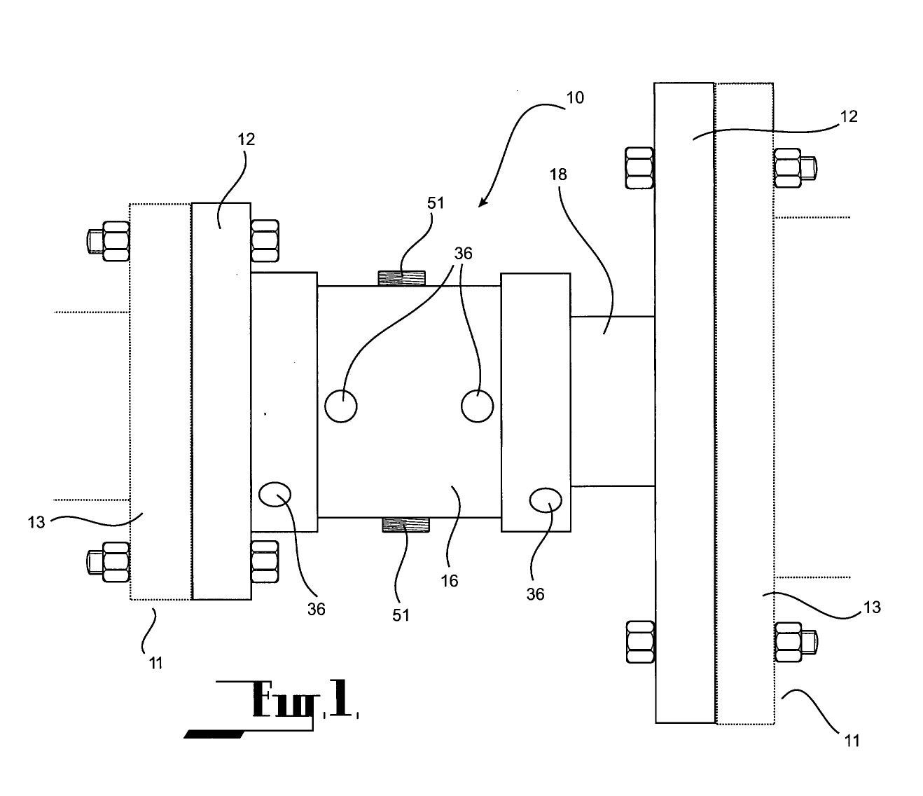

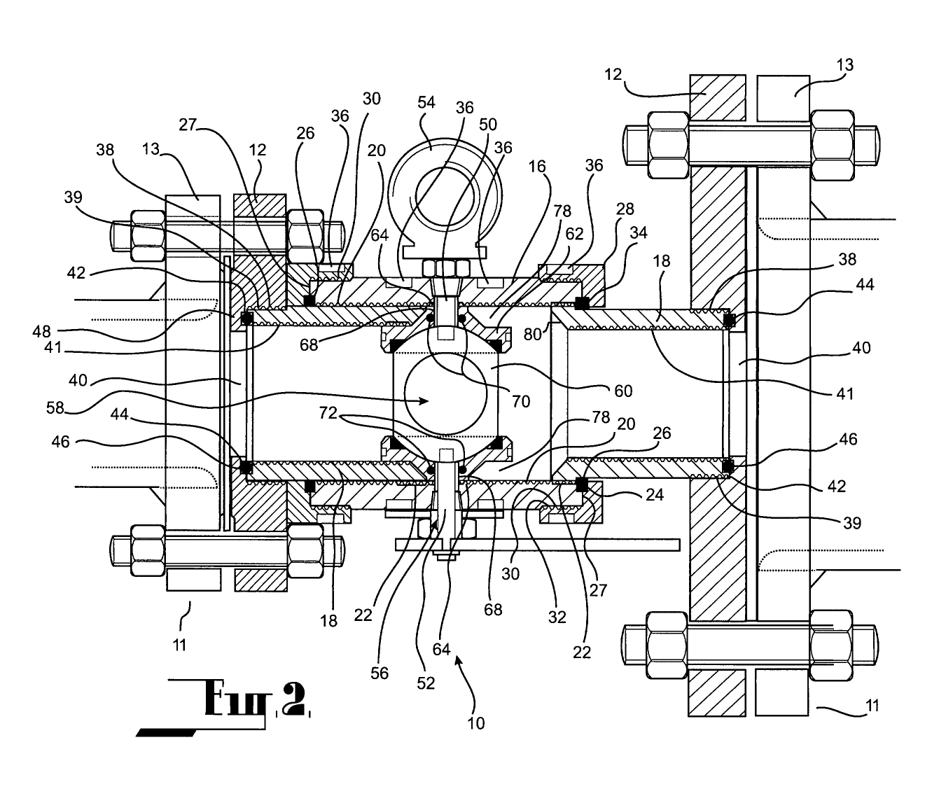

The pipe insert 10 according to the first embodiment, as depicted at FIGS. 1 and 2, provides a connection between spaced ends 11 of a pair of pipes. The insert 10 is of a tubular form and is provided at each end with connecting means in the form of flanges 12 which are adapted to be fixed to corresponding pipe flanges 13 at the ends of the pipes 11 to provide a sealed connection between the pipes. The flanges 12 take a form such that they can be clampingly and sealingly engaged with the pipe flanges 13 of the pipe. The portion of the pipe insert between the flanges 12 is tubular to permit fluid flow between the pipe ends and as will be described later can include flow control and/or sensing elements which can duplicate or provide similar functions to the control element which is finally to be located between the pipe ends.

The portion of the insert 10 between the flanges 12 comprises a plurality of interengaged sections which comprise a central section 16 and a pair of outer sections 18 at either end of the central section 16. The sections 16 and 18 are threadably interconnected in an end to end relationship whereby, by varying the relative longitudinal position of the threadable interconnection between the sections, the length of the insert 10 can be varied.

The central section 16 is provided at its ends with oppositely-handed internal threads 20 while the outer sections 18 are provided at their inner ends with corresponding external threads 22 which interengage with the internal threads 20 to effect the threadable interconnection between the central section 16 and the outer sections 18. The non-threaded portions of the outer faces of each outer section 18 are of a slightly reduced diameter relative to the inner ends to enable the non-threaded outer portions to be receivable within the bore of the central section 16.

The position of each outer section 18 with respect to the central section 16 and thus the length of the pipe insert is adjusted by screwing that outer section clockwise or anticlockwise. The outer sections 18 may be adjustably displaced by different amounts with respect to the central section 16, as shown at FIGS. 1 and 2.

The ends of the central section are each provided with annular locking caps 28. The annular locking caps 28 assist in sealing the interconnection between the central section 16 and the outer sections 18. Each locking cap 28 has an inner thread 30 which is threadably received with an outer thread 32 provided on the outer face of the central section at the respective end. After adjustment of the length of the insert 10, the locking caps 28 are slid along the outer sections 18 and then secured to the ends of the central section 16 to engage respective end faces 27 of the central section 16. A set of notches 36, provided around the perimeter of the locking caps 28 and the central section 16 which enable appropriate tools to be used to apply appropriate tightening torque between the central section 16 and the locking caps 28. Seals 26 are entrapped between the flange of each locking cap 28 and the respective end face of the central section and the outer face of the respective end section. The seals are received around the outer sections 18 and are accommodated in recesses 24, defined between the locking caps 28 and inner end faces 27. The seals 26 are dimensioned so as to be appropriately compressed in the recesses 24 to effect sealing between the central section 16 and the outer sections 18 on the locking caps being applied and tightened as required.

The inner faces of the outer sections 18 are provided with oppositely-handed internal threads 41 so that they may receive further outer sections therein, in accordance with other embodiments as described below. In addition the outer sections 18 are provided, at their outer ends, with external threads 38 to enable them to be engaged with the flanges 12 which in turn are provided with bores 40 having corresponding threads 39 to interengage with threads 38 such that the flanges 12 may be screwed onto, and thus mounted on, the outer sections 18. The removable nature of the flanges 12 means that the insert 10 has the versatility to be used with pipe flanges of varying diameters, types and ratings according to the nature of the pipe flanges with which the pipe insert is to be used.

Seals 46 are received in recesses 44 defined between the outermost end faces 42 of the outer sections 18 and the flanges 12. The seals 46 are dimensioned so as to be appropriately compressed in the recesses 44 to effect sealing between the outer sections 18 and the flanges 12.

The wall of the central section 16 is formed with a pair of opposed radial bores 50 and 52 and each bore is adapted to sealingly receive one of a selection elements which can include control and/or sensing elements. The elements which may include a lifting eye, a ball valve lever assembly, a pressure gauge and a fill/drain point. Where an element does not need not be fitted, one or each radial bore may be sealed with a threaded plug 51, as shown at FIG. 1.

As shown at FIG. 2 and by way of example only, the selected control elements fitted to the first embodiment can comprise a lifting eye 54, received in one bore 50, and a ball valve lever assembly 56, received in the other bore 52. The ball valve lever assembly is associated with a ball valve 58 which may be received in the insert 10. The ball valve 58 comprises the ball valve lever assembly 56, a ball member 60, which is receivable through either end of the central section, and two ball member retaining covers 62 to receive the ball member 60 there between. The retaining covers 62 are provided with external threads 64 to be engageable with the internal threads 20 of the central section 16. Inner ends of the retaining covers 62 are received against annular faces 68 provided near the middle of the central section 16 and integrally formed therewith. Recesses 70 are provided in the retaining covers 62 at their inner ends, the recesses 70 receiving seals 72 which engage the faces 68. The retaining covers 62 have, between their inner and outer ends, tapered annular relief portions 78 to accommodate correspondingly-tapered portions 80 provided at the inner ends of the outer sections 18, thereby allowing for maximum retraction of the outer sections 18, within the central section 16, when the ball valve 58 is being utilised, to increase the range of length adjustment of the insert 10.

In the following description of further embodiments of the invention, like components will be designated with the same reference numerals.

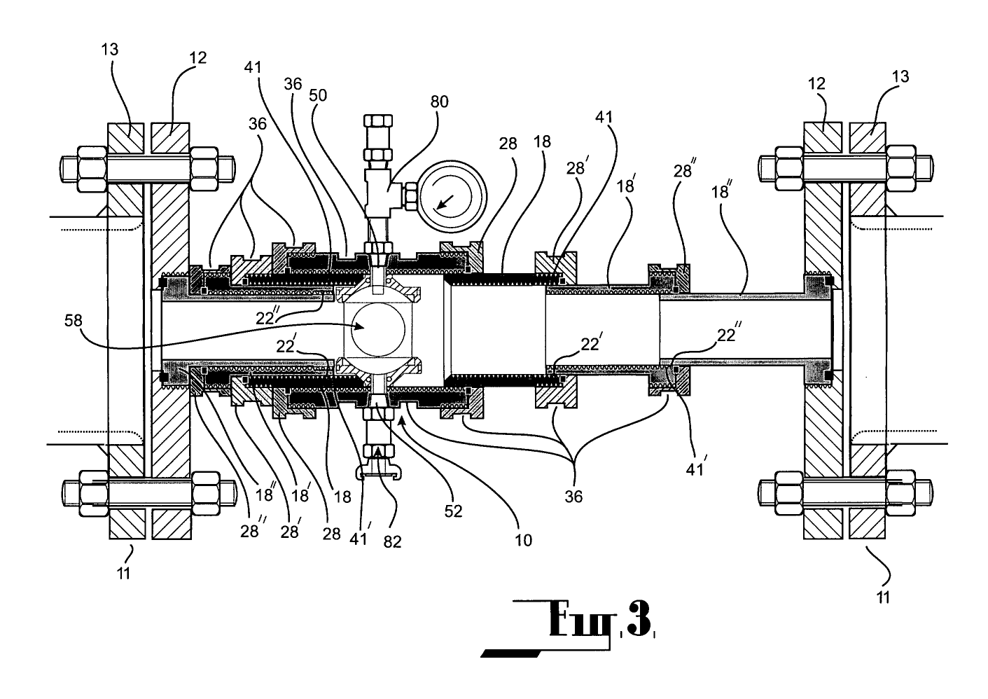

The pipe insert 10 according to the second embodiment, as shown at FIG. 3, is based on a variation of the first embodiment and comprises, in addition to having outer sections 18 at each side of the central section 16, a pair of threadably interengaged, telescopically interconnected further outer sections 18′ and 18″ at each end. This enables the pipe insert 10 to be used in connecting a variety of pipe ends having a greater variation in their degree of separation since the further outer sections 18′ and 18″ provide the pipe insert 10 of the second embodiment with a greater range of length adjustment when compared to the pipe insert of the first embodiment.

The central section 16 and outer sections 18 are the same pieces as used in the case of the first embodiment, the additional pieces being suitably configured so that the insert 10 can accommodate a ball valve 58 (as shown in broken lines in FIG. 3), with the outer sections 18, 18′ and 18″ fully retracted.

The further outer sections 18′ are provided, at their inner ends, with external threads 22′ which engage with the internal threads 41 respectively, provided in the outer sections 18. The remaining portions of the outer face of each further outer section 18′ are of a reduced diameter relative to the inner ends, so as to enable the further outer sections 18′ to be received within the outer sections 18.

The further outer sections 18′ are provided with internal, oppositely-handed threads 41′ which engage with corresponding external threads 22″ provided at the inner ends of the further outer sections 18″. The remaining portions of the outer face of each further outer section 18″ are also of a reduced diameter relative to the inner ends, so as to enable the further outer sections 18″ to be received within the further outer sections 18′.

The flanges 12 are mounted to the outer ends of the further outer sections 18″, those outer ends being configured as described in connection with the first embodiment to provide for sealing connection with the flanges 12.

Annular locking caps 28, 28′ and 28″, with associated sealing arrangements therebetween, are provided at the connections between each section, the locking caps and sealing arrangements being of the type described in connection with the first embodiment.

By way of example only, the selected control elements for the second embodiment comprises a pressure gauge 80, received in bore 50, and a fill/drain point 82, received in bore 52. Again, where a control elements need not be fitted, one or each radial bore may be sealed with a threaded plug, as shown at FIG. 1 in connection with the first embodiment.

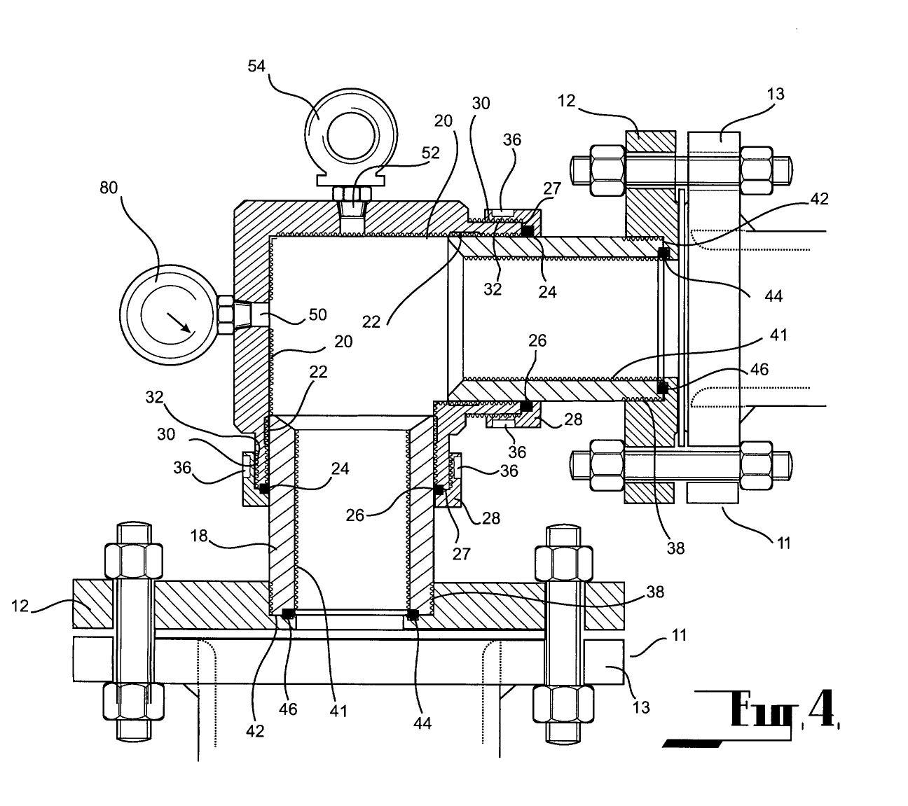

The pipe insert 10 according to the third embodiment, as depicted at FIG. 4, is also a variation of the first embodiment with the exception that the central section 16, comprises 90° elbow piece. The insert is thus adjustable along two non-parallel axes and as such is adapted to provide a connection between two spaced pipe ends 11 which are arranged perpendicularly.

The radial bores 50 and 52 in the case of the third embodiment are arranged at 90°, rather than being opposed.

By way of example only, the selected control elements for the third embodiment comprise a pressure gauge 80, received in bore 50, and a lifting eye 54, received in bore 52. Again, where a control element need not be fitted, one or each radial bore may be sealed with a threaded plug, as already described.

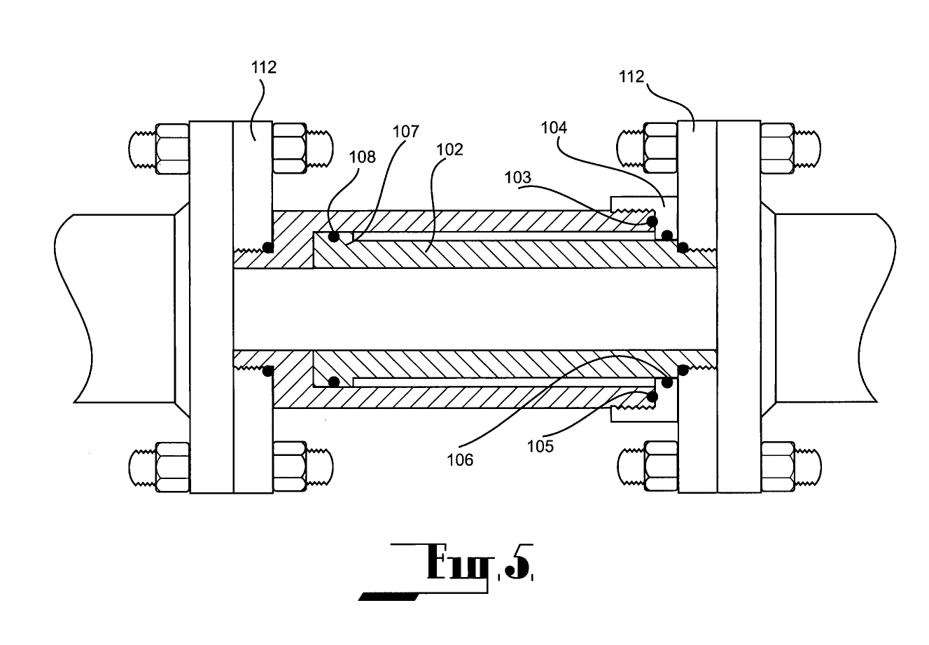

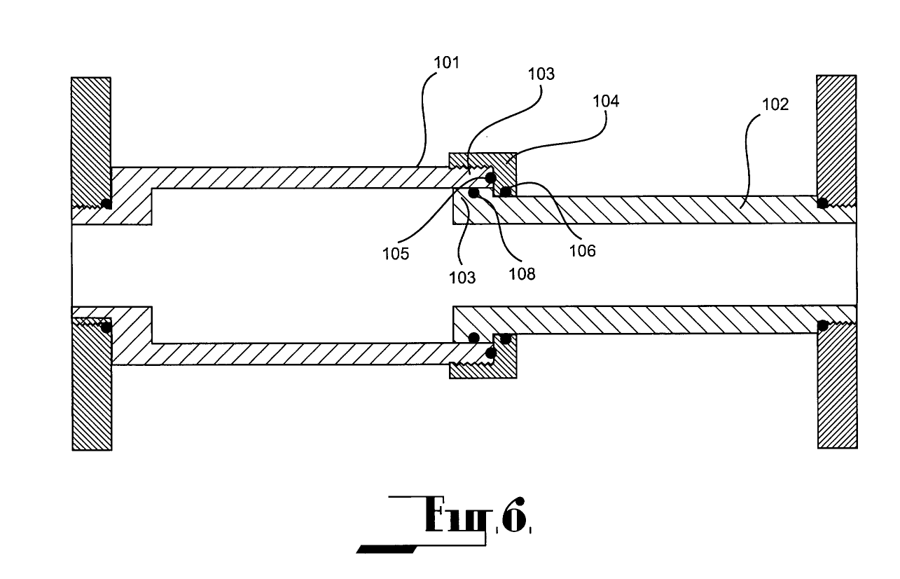

The fourth embodiment of the invention as shown at FIGS. 5 and 6 comprises a pair of tubular sections 101 and 102 which are telescopically connected. The free end of each section supports a flange 112 through a suitable threadable interconnection as in the case of the previous embodiment. The inner end 103 of the larger diameter section 101 is associated with an annular seal cover 104 which is threadably engaged with the inner end 103 and retains a first seal 105 between the end face of the section 101 and the seal cover and a second seal 106 between the inner radial face of the seal cover and the outer face of the other section 102. The inner end of the other section 102 is formed with an outwardly directed flange 107 which has greater outer diameter than the inner diameter of the seal cover to enable retention between the sections and a third seal 108 is supported by the outer radial face of the flange for sealing engagement with the inner bore of the larger section 102. Because of the telescoping nature of the connection sections 101 and 102 the length of the pipe insert can be varied as required

There exist further embodiments wherein the number of outer sections provided to each side differs from that in connection with the first and second embodiments. Moreover, it will be appreciated that the number of outer sections provided to one side of the central section may differ from the number provided to the other side.

Other embodiments exist wherein there is a transverse offset between the outer section(s) to one side of the central section and the outer section(s) to the other side of the central section to accommodate for circumstances where the pipe ends are out of coaxial alignment.

In addition, there exist alternative embodiments which are adapted to connect more than two pipe ends, for example inserts formed as tee-pieces or four-way pieces, those inserts being adjustable in some or all longitudinal axes, so as to vary the positions of the connectors according to the spacing of the pipe ends.

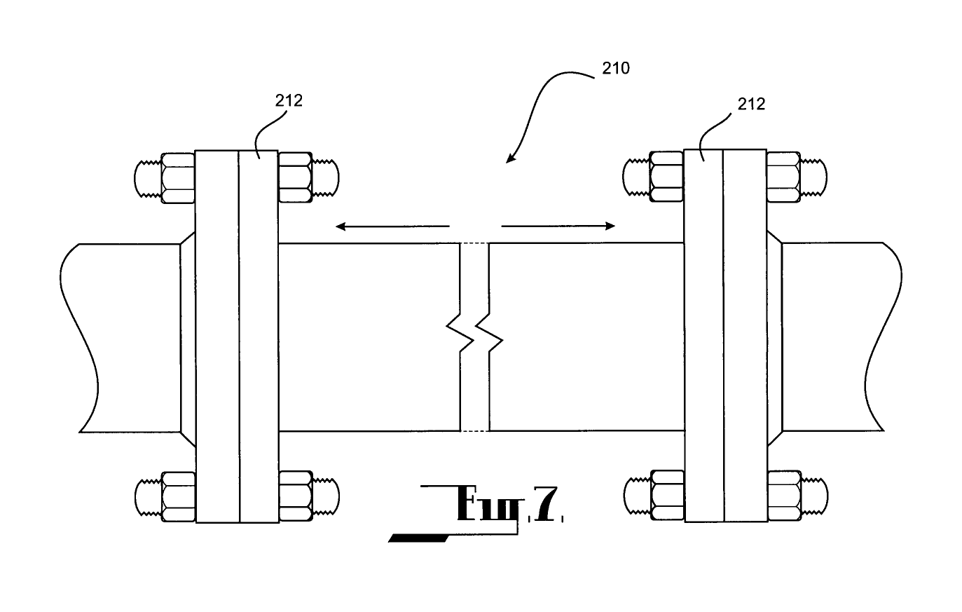

A further embodiment as shown schematically at FIG. 7 comprises a situation where the pipe insert does not need to provide fluid communication between the pipe ends during the period of time that the pipe insert is to be in position between the pipe ends. As a result portion 210 between the flanges 212 comprises a member which is extendible and which has sufficient structural integrity to withstand the forces exerted thereon during the relevant activity.

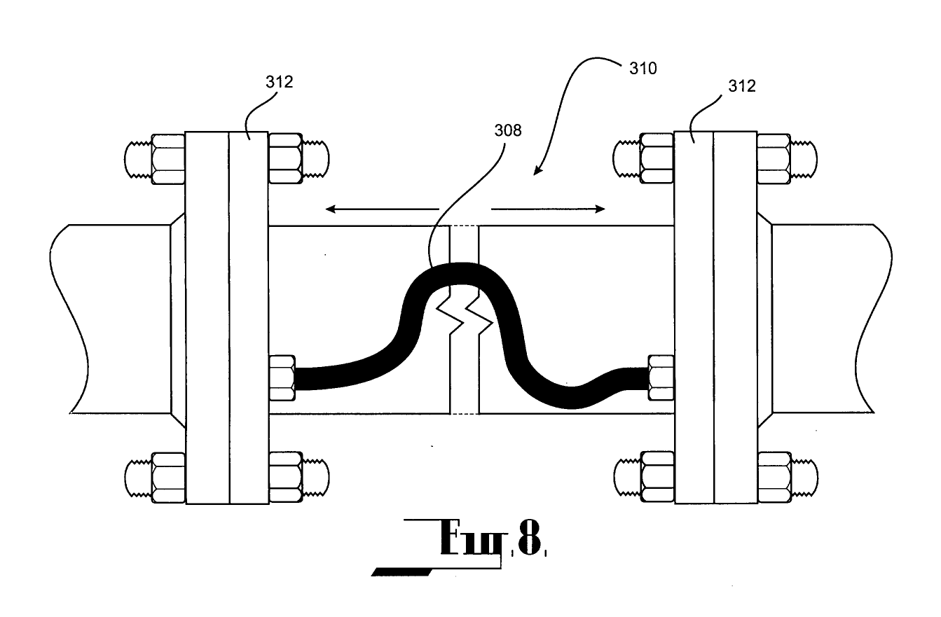

A further embodiment as shown schematically at FIG. 8 comprises a situation where the portion 310 of the pipe insert between the flanges does not provide full fluid communication between the pipe ends during the period of time that the pipe insert is to be in position between the pipe ends. As a result portion 310 between the flanges 312 comprises a member which is extendible and which has sufficient structural integrity to withstand the forces exerted thereon during the relevant activity. To accommodate for the required fluid flow a flexible flow line 308 extends between the flanges 312 to provide for the required fluid flow between the pipe ends and suitable flow control and/or sensing elements are associated with the flexible flow line.

The method of assembly, adjustment and installation of the insert 10 will now be described in relation to the first, second and third embodiments. It will be understood that the seals associated with the various components to be assembled will already be located in place during the assembly.

Prior to assembly, adjustment and installation of the insert 10, the flanges 13, if not present already, are welded, or otherwise fixed, into position on the pipe ends 11. An accurate measurement of the separation between the flanges 13 is then made.

A determination of the appropriate number of sections from which to assemble the insert 10 is then made, such a determination being based on the size and spacing of the pipe ends 11. Assembly of the insert 10 is then commenced.

The first step in the assembly of the insert 10 will generally be that of fitting the appropriate elements to, and/or plugging, the bores 50 and 52. If the ball valve 58 is required, the ball member 60 is inserted into the central section 16, and the retaining covers 62 are then screwed into either side of the central section 16 to retain the ball member 60 therebetween. The ball valve lever assembly 56 is then screwed into the appropriate bore 50 or 52. The lifting eye 54 will often be fitted to one bore to facilitate subsequent installation of the insert 10. The outer sections 16 are then screwed into the central section 16 and the locking caps 28 are then slid over the those outer sections 18. If further outer sections 18′ are required, they are screwed into the outer ends of the outer sections 18. Locking caps 28′ are then slid over the further outer sections 18′. If additional further outer sections 18″ are required, they are screwed into the outer ends of the further outer sections 18′. Locking caps 28″ are then slid over the additional further outer sections 18″. The flanges 12, selected according to the dimensions of the flanges 13 to which they are to be connected, are then screwed onto the outer ends of the outermost sections 18, 18′ or 18″.

The interconnected sections are screwed with respect to each other until the overall length is adjusted according to the spacing of the flanges 13, allowing for gaskets and the like. After correct adjustment of the length of the insert 10, the locking caps are screwed into position to lock the interconnected sections and to effect the sealing therebetween. The appropriate tightening torque is provided by means of hook spanners engaged with the notches 36, as described above.

The insert 10 is then installed. To this end, the lifting eye 54, if fitted, may be utilised to lift the insert 10 into position. The flanges 12 are then connected to the flanges 13 in the conventional manner to complete the installation.

The insert 10 may be adjusted in the at least one longitudinal axis, according to the longitudinal dimension(s) of the control element which will ultimately be installed in its place. The insert 10 can then be fitted during the construction phase in the piping systems at all control element locations, allowing for the appropriate spacing and piping alignment. Testing and cleaning can then be carried out without the need to remove the insert 10.

Moreover, the mechanical integrity of the insert 10 may be approved prior to installation, thereby eliminating the need for testing of the insert 10 in the field.

It should be appreciated that the scope of the present invention need not be limited to the particular scope of the embodiments described above.

1. A pipe insert which in use is to provide a connection between at least two spaced pipe ends which are fixed relative to each other, said pipe ends each having first connection means enabling the connection of an appliance between the pipe ends, the insert in use being intended to extend across the space between the pipe ends to replace the appliance and provide a fluid tight interconnection with between each pipe end and the abutting end of the insert, the insert having at least two ends, the pipe insert being adjustable to be able to vary the relative displacement between the ends, each end having second connection means adapted in use to be sealing interconnected with the first connection means.

2. A pipe insert as claimed at claim 1 wherein the pipe insert is able to accommodate at least some of the intended fluid flow between the pipe ends.

3. A pipe insert as claimed at claim 2 wherein the pipe insert constitutes a flow conduit between the ends.

4. A pipe insert as claimed at claim 3 wherein the flow conduit comprises an integral part of the pipe insert.

5. A pipe insert as claimed at claim 3 wherein the flow conduit is of a flexible or extendable nature.

6. A pipe insert as claimed at claim 2 wherein the pipe insert is adapted to receive at least one of a selection of flow control and/or sensing elements.

7. A pipe insert as claimed at claim 2 wherein the pipe insert incorporates a flow control and/or sensing elements.

8. A pipe insert as claimed at claim 1 wherein the pipe insert is not able to accommodate flow between the pipe ends.

9. A pipe insert as claimed at claim 1 wherein, the pipe insert comprises a plurality of interengaged sections which are displaceable relative to each other to vary the relative displacement between the ends of the insert, and a locking means is provided between the sections, said locking means being capable of being released to permit relative movement between the sections.

10. A pipe insert as claimed at claim 9 wherein the sections accommodate for fluid flow between the flanges and are sealingly interconnected.

11. A pipe insert as claimed at claim 10 wherein the sections are telescopingly interengaged.

12. A pipe insert as claimed at claim 10 wherein, the sections are threadably interengaged, whereby the relative displacement is varied by varying the relative longitudinal position of the threadable interconnection between the sections.

13. A pipe insert as claimed at claim 1 wherein the second connection means are removable from the ends and the second connection means which are to affixed to the ends can be are selectable from a plurality of differing forms of second connection means adapted to conform with the first connection means of the pipe ends of differing sizes.

14. A pipe insert as claimed at claim 13 wherein the ends of the insert are displaceable along a common axis.

15. A pipe insert as claimed at claim 13 wherein the ends of the insert are displaceable along at least two axes which are angularly displaced from each other.

16. A pipe insert as claimed at claim 15 wherein the ends of the insert are displaceable along two axes which are substantially perpendicular to each other.

17. A pipe insert as claimed at claim 13 wherein the ends of the insert are displaceable along at least two axes which are spaced from each other.

18. (canceled)

19. A method of connecting at least two spaced pipe ends which are fixed relative to each other, said pipe ends each having first connection means enabling the connection of an appliance between the pipe ends, the method comprising the steps of:
providing an insert of the form as claimed at any one of the preceding claims between the at least two spaced pipe ends;
adjusting the length of insert to cause relative displacement between the ends of the insert according to the spacing between the pipe ends;
inserting the inset into the space between the pipe ends; and
connecting the insert to the pipe ends with the abutting first and second connection means to provide a fluid tight interconnection therebetween.

20. (canceled)

21. A pipe insert as claimed at claim 19 wherein the first connection means each comprise a flange at the respective pipe end and said second connection means each comprise a flange at the respective end wherein the first and second connection means are of a complementary form.

22. A pipe insert as claimed at claim 21 wherein the pipe insert is able to accommodate the flow and pressure conditions anticipated for the appliance in use.

23. A pipe insert as claimed at claim 22 wherein the pipe insert is configured and such that it can accommodate the anticipated mechanical loadings anticipated to be applied to the appliance in use.
